(19) United States
(12) Patent Application Publication
(10) Pub. No.: US 2015/0288995 A1
(43) Pub. Date: Oct. 8, 2015

(54) METHOD AND APPARATUS FOR TRANSMITTING AND RECEIVING HYBRID BROADCASTING

(71) Applicants: Electronics and Telecommunications Research Institute, Daejeon (KR); DIGICAPS CO., LTD., Seoul (KR)

(72) Inventors: Byungjun BAE, Daejeon (KR); Woo-Suk KIM, Daejeon (KR); Hyun-Jeong YIM, Daejeon (KR); Hyoungsoo LIM, Daejeon (KR); Kyu Tae YANG, Daejeon (KR); Namho HUR, Sejong (KR); Sungheun OH, Seoul (KR); Minyong KIM, Seoul (KR); Yongtae SHIN, Seoul (KR)

(21) Appl. No.: 14/669,136

(22) Filed: Mar. 26, 2015

(30) Foreign Application Priority Data
Apr. 2, 2014 (KR) 10-2014-0039604

(51) Int. Cl. H04N 21/236; H04N 21/2389; H04N 21/262; H04N 21/643; H04N 21/4385; H04N 21/462; H04N 21/858; H04N 21/2365; H04N 21/438

(52) U.S. Cl. CPC H04N 21/23614; H04N 21/2365; H04N 21/2389; H04N 21/262; H04N 21/4381; H04N 21/4385; H04N 21/4622; H04N 21/8586; H04N 21/64322

(57) ABSTRACT

A hybrid broadcasting transmitting apparatus generates signaling information including a stream type of a plurality of broadcasting programs and a transmitting network type of the plurality of broadcasting programs, transmits signaling information and a broadcasting stream corresponding to a portion of a plurality of broadcasting programs through the communication network, and transmits signaling information and a broadcasting stream corresponding to the remaining portions of a plurality of broadcasting programs through the broadcasting network.

### CROSS-REFERENCE TO RELATED APPLICATION

This application claims priority to and the benefit of Korean Patent Application No. 10-2014-0039604 filed in the Korean Intellectual Property Office on Apr. 2, 2014, the entire contents of which are incorporated herein by reference.

### BACKGROUND OF THE INVENTION

(a) Field of the Invention

The present invention relates to a method and apparatus for transmitting and receiving hybrid broadcasting. More particularly, the present invention relates to a method and apparatus for providing a hybrid broadcasting service in next generation digital broadcasting based on a broadcasting communication convergence network.

(b) Description of the Related Art

Existing terrestrial digital broadcasting provides broadcasting contents through a broadcasting network and thus has a limited data rate.

A medium that provides broadcasting contents through a communication network like an IPTV and a smart TV has been released, but such mediums are less connected with broadcasting contents that are transmitted through a broadcasting network and are thus recognized as a separate communication service. In the IPTV, broadcasting contents are retransmitted through a separate communication network, but in the smart TV, broadcasting contents through a broadcasting network and Internet contents through a communication network are less interlocked. That is, communication is much accessed to a broadcasting service, but broadcasting is less accessed to a communication service.

Further, currently, due to launch of a UHD broadcasting service having a large data rate, a data rate through a broadcasting network is further lowered. That is, when transmitting UHD broadcasting contents through a broadcasting network, even if a codec having high compression efficiency is adapted, it is difficult to simultaneously transmit existing HD broadcasting contents together with UHD broadcasting contents. At a transition period in which an existing HD broadcasting service is not completely converted to a UHD broadcasting service, there is a high possibility that an existing HD broadcasting service and a new UHD broadcasting service coexist.

Therefore, in an aspect of broadcasting service, a method of simultaneously providing an existing HD broadcasting service and a new UHD broadcasting service through a broadcasting communication convergence network is requested.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for transmitting and receiving hybrid broadcasting having advantages of being capable of simultaneously providing an existing HD broadcasting service and a new UHD broadcasting service.

An exemplary embodiment of the present invention provides a method of transmitting hybrid broadcasting using a broadcasting network and a communication network in a hybrid broadcasting transmitting apparatus. The method includes: generating signaling information including a stream type and a transmitting network type of a plurality of broadcasting programs; transmitting the signaling information and broadcasting stream corresponding to a portion of the plurality of broadcasting programs through the communication network; and transmitting the signaling information and broadcasting stream corresponding to the remaining portions of the plurality of broadcasting programs through the broadcasting network.

The stream type of the broadcasting program may represent image quality of the broadcasting program, and the transmitting network type may represent the broadcasting network and the communication network.

The signaling information may further include transition information of a transmitting network of the plurality of broadcasting programs.

The signaling information may further include a related uniform resource locator (URL), when the transmitting network is a broadcasting program corresponding to a communication network.

The transmitting of the signaling information and broadcasting stream corresponding to the remaining portions may include: multiplexing the signaling information and broadcasting streams of a broadcasting program of the remaining portions; and transmitting the multiplexed signal through the broadcasting network.

The transmitting of the signaling information and broadcasting stream corresponding to a portion may include streaming each of the signaling information and broadcasting streams corresponding to the portion through the communication network.

Another embodiment of the present invention provides a method of receiving hybrid broadcasting using a broadcasting network and a communication network in a hybrid broadcasting receiving apparatus. The method include: receiving signaling information including a stream type and a transmitting network type of each broadcasting program from the hybrid broadcasting transmitting apparatus; analyzing the signaling information; selecting a broadcasting program to view among a plurality of broadcasting programs; and playing a broadcasting stream that is provided through the communication network and the broadcasting network according to a transmitting network type of the selected broadcasting program based on the signaling information.

The stream type of the broadcasting program may represent image quality of the broadcasting program, and the transmitting network type may represent the broadcasting network and the communication network.

The signaling information may further include transition information of a transmitting network of the plurality of broadcasting programs.

The signaling information may further include a related uniform resource locator (URL), when the transmitting network is a broadcasting program corresponding to a communication network.

The playing of broadcasting stream may include: requesting streaming of the selected broadcasting program, when a transmitting network type of the selected broadcasting program is the communication network; and receiving a broadcasting stream of the selected broadcasting program by streaming through the communication network.

The playing of broadcasting stream may include receiving a broadcasting stream through the broadcasting network, when a transmitting network type of the selected broadcasting program is the broadcasting network, and the broadcasting stream and the signaling information may be multiplexed by the hybrid broadcasting transmitting apparatus to be transmitted through the broadcasting network.

Yet another embodiment of the present invention provides an apparatus that transmits hybrid broadcasting using a broadcasting network and a communication network. The hybrid broadcasting transmitting apparatus includes a scheduling server, a signaling server, a streaming server, a broadcasting multiplexer, and a broadcasting service transmitter. The scheduling server determines a stream type, a transmitting network type, and a broadcasting time of a plurality of broadcasting programs. The signaling server generates signaling information including a stream type, a transmitting network type, and a broadcasting time of the plurality of broadcasting programs. The streaming server transmits the signaling information and broadcasting stream of a broadcasting program to transmit to the communication network while streaming. The broadcasting multiplexer multiplexes the signaling information and broadcasting stream of a broadcasting program to transmit to the broadcasting network. The broadcasting service transmitter transmits the multiplexed signal through the broadcasting network.

The stream type of the broadcasting program may represent image quality of the broadcasting program, and the transmitting network type may represent the broadcasting network and the communication network.

The signaling information may further include transition information of a transmitting network of the plurality of broadcasting programs.

Yet another embodiment of the present invention provides an apparatus that receives hybrid broadcasting using a broadcasting network and a communication network. The hybrid broadcasting receiving apparatus includes a signaling analysis server, a service selector, and a service player. The signaling analysis server determines a stream type and a transmitting network type of each broadcasting program by analyzing signaling information that is transmitted through the broadcasting network and the communication network. The service selector selects a broadcasting program to view among a plurality of broadcasting programs. The service player plays broadcasting stream that is provided through the communication network or the broadcasting network according to a transmitting network type of the selected broadcasting program.

The hybrid broadcasting receiving apparatus may further include a broadcasting service receiver and a communication service receiver. The broadcasting service receiver may receive a signal in which the signaling information and broadcasting stream of the each broadcasting program is multiplexed through the broadcasting network. The communication service receiver may receive a broadcasting stream of each broadcasting program and the signaling information through the communication network by streaming.

The stream type of the broadcasting program may represent image quality of the broadcasting program, and the transmitting network type may represent the broadcasting network and the communication network.

The signaling information may further include transition information of a transmitting network of the plurality of broadcasting programs.

The hybrid broadcasting receiving apparatus may further include a service controller that transfers a broadcasting stream that is provided through the broadcasting network or the communication network according to a transmitting network type of the selected broadcasting program to the service player.

### BRIEF DESCRIPTION OF THE DRAWINGS

FIG. 1 is a diagram illustrating a method of transmitting and receiving hybrid broadcasting according to an exemplary embodiment of the present invention.

FIG. 2 is a diagram illustrating a hybrid broadcasting transmitting apparatus according to an exemplary embodiment of the present invention.

FIG. 3 is a flowchart illustrating a method of transmitting hybrid broadcasting according to an exemplary embodiment of the present invention.

FIG. 4 is a diagram illustrating a hybrid broadcasting receiving apparatus according to an exemplary embodiment of the present invention.

FIG. 5 is a flowchart illustrating a method of receiving hybrid broadcasting according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for transmitting and receiving hybrid broadcasting according to an exemplary embodiment of the present invention will be described in detail with reference to the drawings.

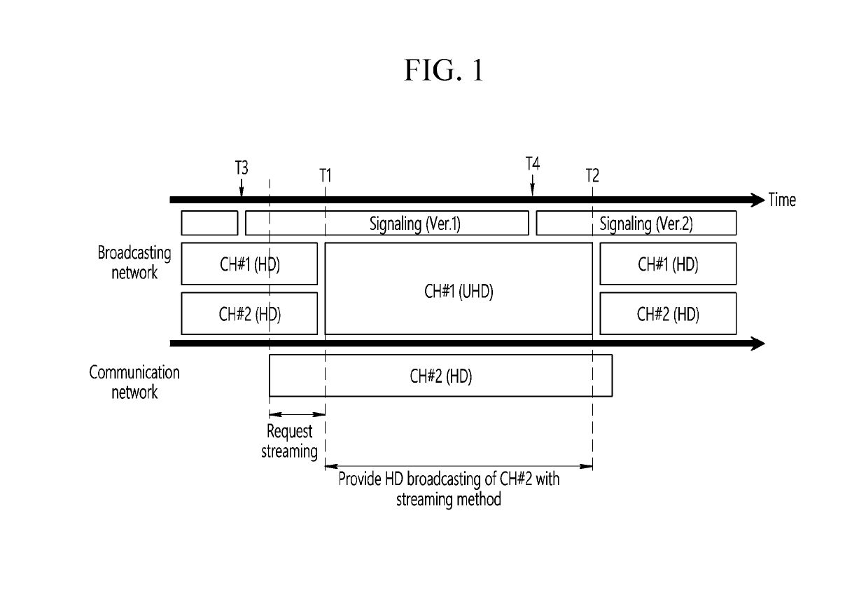

FIG. 1 is a diagram illustrating a method of transmitting and receiving hybrid broadcasting according to an exemplary embodiment of the present invention.

Referring to FIG. 1, a hybrid broadcasting transmitting apparatus provides an HD broadcasting service through each of broadcasting channels CH #1 and CH #2.

When the hybrid broadcasting transmitting apparatus provides a UHD broadcasting service through a channel CH #1 from a time point T1, the hybrid broadcasting transmitting apparatus combines two channels CH #1 and CH #2 due to a limited bandwidth of a broadcasting network to provide one UHD broadcasting service.

The hybrid broadcasting transmitting apparatus provides an HD broadcasting service that has been provided through the channel CH #2 through a communication network from the time point T1, thereby simultaneously providing a UHD broadcasting service and the HD broadcasting service. The HD broadcasting service through a communication network may be provided by a streaming method.

The hybrid broadcasting transmitting apparatus notifies a hybrid broadcasting receiving apparatus of a changed transmitting network type of a broadcasting program of the channel CH #2 through signaling information [signaling (Ver. 1)] at a time point T3 before the time point T1. That is, signaling information [signaling (Ver. 1)] may include a stream type, a transmitting network type, and a broadcasting time of each broadcasting program.

The hybrid broadcasting receiving apparatus receives signaling information [signaling (Ver. 1)] from the hybrid broadcasting transmitting apparatus. The hybrid broadcasting receiving apparatus determines a stream type, a transmitting network type, and a broadcasting time of each broadcasting program through signaling information [signaling (Ver. 1)].

When a viewer wants to view an HD broadcasting service of a channel CH #2 that is provided through a communication network, the hybrid broadcasting receiving apparatus requests streaming of the HD broadcasting service by accessing a communication network before the time point T1 and provides the HD broadcasting service with a streaming method at the time point T1.

When the UHD broadcasting service is terminated at a time point T2, the hybrid broadcasting transmitting apparatus again transmits an HD broadcasting service that has been temporarily provided through a communication network through a channel CH #2 of a broadcasting network.

The hybrid broadcasting transmitting apparatus notifies the hybrid broadcasting receiving apparatus of a changed transmitting network type of the HD broadcasting service through signaling information [signaling (Ver. 2)] at a time point T4 before the time point T2.

The hybrid broadcasting receiving apparatus determines a changed transmitting network of the HD broadcasting service through signaling information [signaling (Ver. 2)] and provides the HD broadcasting service through the channel CH #2 of a broadcasting network from the time point T2.

In this way, when the hybrid broadcasting transmitting apparatus cannot provide a UHD broadcasting service through a channel providing an HD broadcasting service due to a limited bandwidth of a broadcasting network, by using a communication network as an auxiliary network of broadcasting, the hybrid broadcasting transmitting apparatus combines at least two channels CH #1 and CH #2 to provide a UHD broadcasting service and provides the HD broadcasting service that is provided through the channel CH #2 of the broadcasting network through a communication network. Therefore, while maintaining the number of broadcasting services, a viewer can view a desired broadcasting service.

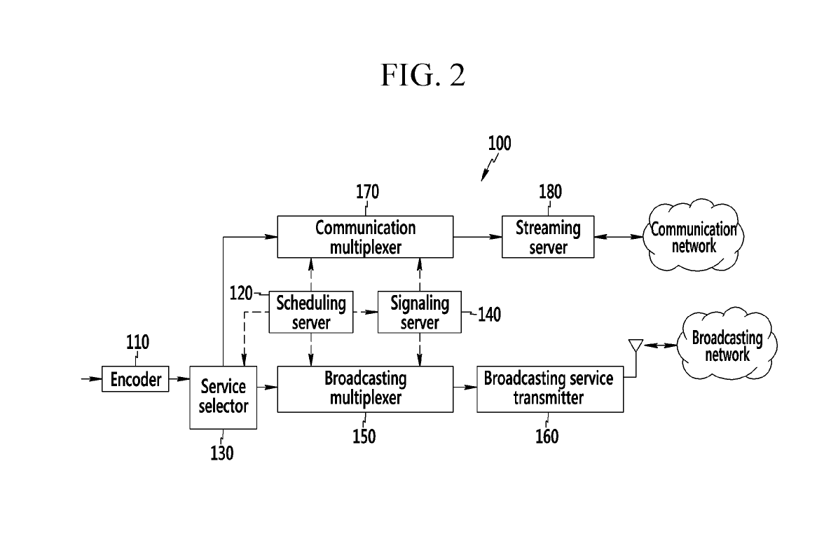

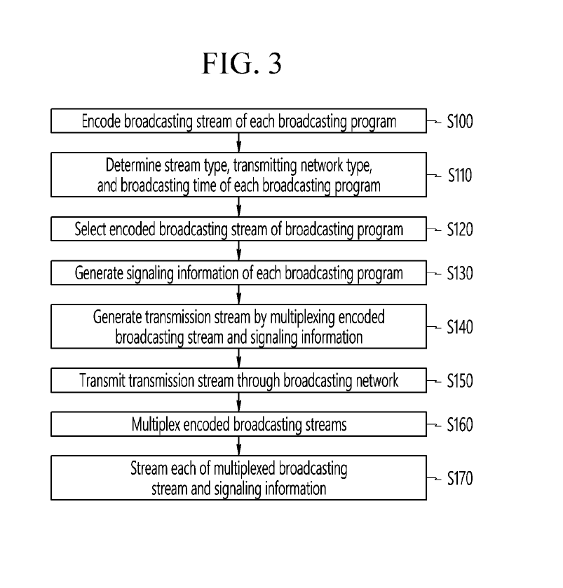

FIG. 2 is a diagram illustrating a hybrid broadcasting transmitting apparatus according to an exemplary embodiment of the present invention, and FIG. 3 is a flowchart illustrating a method of transmitting hybrid broadcasting according to an exemplary embodiment of the present invention.

Referring to FIG. 2, the hybrid broadcasting transmitting apparatus 100 includes an encoder 110, a scheduling server 120, a service selector 130, a signaling server 140, a broadcasting multiplexer 150, a broadcasting service transmitter 160, a communication multiplexer 170, and a streaming server 180.

Referring to FIG. 3, the encoder 110 encodes a broadcasting stream of each broadcasting program and transfers the encoded broadcasting stream to the service selector 130 (S100). The broadcasting stream may include at least one of a sound, an image, and data stream corresponding to the broadcasting program.

The scheduling server 120 determines a stream type, a transmitting network type, and a broadcasting time of each broadcasting program (S110), and transfers the stream type, the transmitting network type, and the broadcasting time of each broadcasting program to the service selector 130, the signaling server 140, the broadcasting multiplexer 150, and the communication multiplexer 170. A stream type of a broadcasting program is related to image quality of a broadcasting program such as High Definition (HD) and Ultra High Definition (UHD). A transmitting network type is a communication network or a broadcasting network.

The service selector 130 determines a stream type, a transmitting network type, and broadcasting time of each broadcasting program, and selects an encoded broadcasting stream of a corresponding broadcasting program according to a broadcasting time of each broadcasting program (S120) and transfers the selected broadcasting stream to the broadcasting multiplexer 150 or the communication multiplexer 170 according to a transmitting network type of a corresponding broadcasting program.

The signaling server 140 generates signaling information of each broadcasting program based on a stream type, a transmitting network type, and a broadcasting time of each broadcasting program (S130), and transfers the signaling information to the broadcasting multiplexer 150 or the communication multiplexer 170. The signaling information includes information for viewing a broadcasting program in a receiving apparatus, such as configuration information of each broadcasting channel and configuration information of a broadcasting program that is included within each broadcasting channel. The broadcasting channel may include a channel of a communication network as well as a channel of a broadcasting network. That is, signaling information includes a stream type and a transmitting network type of each broadcasting program, and transition information of a transmitting network of each broadcasting program. In a broadcasting program in which a transmitting network is a communication network, signaling information may further include a related Uniform Resource Locator (URL). A stream type and a transmitting network type of each broadcasting program and transition information of a transmitting network of each broadcasting program may be defined within a PMT that is defined in, for example, an MPEG-2 system. In digital broadcasting, in addition to the PMT that is defined in the MPEG-2 system, each broadcasting standard organization defines a data structure for providing configuration information of a broadcasting channel. For example, there are a Program and System Information Protocol PSIP that is defined in an Advanced Television System Committee (ATSC), and a Service Information (SI) specification that is defined in Society of Cable Telecommunications Engineers (SCTE). In the ATSC, a stream type and a transmitting network type of each broadcasting program and transition information of a transmitting network of each broadcasting program may be defined in a predetermined field within the PSIP, and in DVB, a stream type and a transmitting network type of each broadcasting program and transition information of a transmitting network of each broadcasting program may be defined in a predetermined field within the SI. Further, in addition to a PSIP of the ATSC or an SI of DVB, in a next generation broadcasting method, a stream type and a transmitting network type of each broadcasting program and transition information of a transmitting network of each broadcasting program may be defined in a predetermined field within a signaling specification that is defined in each broadcasting method. A transmitting network type and transition information of the transmitting network may be represented as described in Table 1.

TABLE 1

| Field value | Description |
|---|---|
| 0 | Stream of a corresponding broadcasting program is |
| | simultaneously transmitted to a broadcasting network |
| | and a communication network. |
| 1 | Stream of a corresponding broadcasting program is |
| | transmitted only to a communication network and |
| | not a broadcasting network. |
| 2 | Stream of a corresponding broadcasting program is |
| | presently simultaneously transmitted to a broadcasting |
| | network and a communication network, but will be |
| | transmitted only to a communication network later. |
| 3 | Stream of a corresponding broadcasting program is |
| | presently simultaneously transmitted to a broadcasting |
| | network and a communication network, but will be |
| | transmitted only to a broadcasting network later. |

Whenever a broadcasting program is added or whenever a transmitting network type of a broadcasting program is changed, the signaling server 140 may generate signaling information.

By multiplexing encoded broadcasting stream and signaling information that is transferred from the service selector 130, the broadcasting multiplexer 150 generates a transmission stream corresponding to a broadcasting channel (S140) and transfers the transmission stream to the broadcasting service transmitter 160 based on a stream type, a transmitting network type, and a broadcasting time of each broadcasting program.

The broadcasting service transmitter 160 transmits the transmission stream through a broadcasting network (S150).

Further, the communication multiplexer 170 multiplexes encoded broadcasting streams that are transferred from the service selector 130 (S160) and transfers the multiplexed broadcasting streams to the streaming server 180 in consideration of transmission to a communication network and transmits signaling information including a stream type, a transmitting network type, and a transmitting time of each broadcasting program to the streaming server 180.

The streaming server 180 streams a broadcasting signal corresponding to each of a multiplexed broadcasting stream and signaling information through a communication network (S170). The streaming server 180 may stream a broadcasting signal by a request of the hybrid broadcasting receiving apparatus.

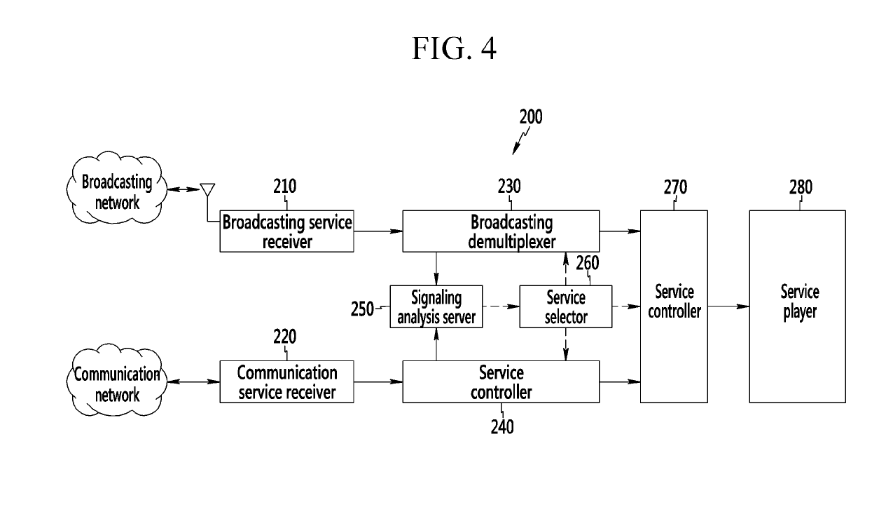

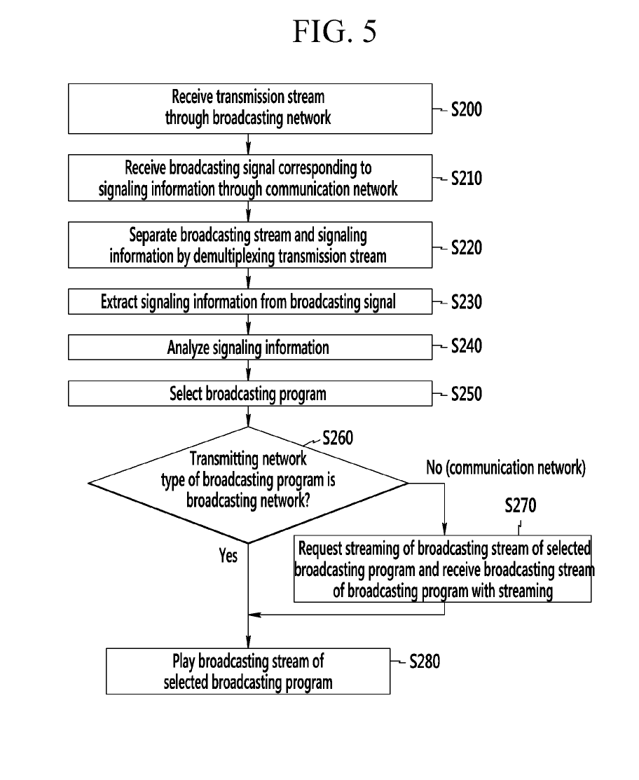

FIG. 4 is a diagram illustrating a hybrid broadcasting receiving apparatus according to an exemplary embodiment of the present invention, and FIG. 5 is a flowchart illustrating a method of receiving hybrid broadcasting according to an exemplary embodiment of the present invention.

Referring to FIG. 4, a hybrid broadcasting receiving apparatus 200 includes a broadcasting service receiver 210, a communication service receiver 220, a broadcasting demultiplexer 230, a communication demultiplexer 240, a signaling analysis server 250, a service selector 260, a service controller 270, and a service player 280.

Referring to FIG. 5, the broadcasting service receiver 210 receives a transmission stream that is transmitted through a broadcasting network (S200) and transfers the received transmission stream to the broadcasting demultiplexer 230.

The communication service receiver 220 receives a broadcasting signal corresponding to signaling information through a communication network (S210) and transfers the received broadcasting signal to the communication demultiplexer 240. The communication service receiver 220 requests a broadcasting signal from the streaming server 180 of the hybrid broadcasting transmitting apparatus 100, and the streaming server 180 transmits the broadcasting signal by the request.

By demultiplexing transmission stream that is received through the broadcasting service receiver 210, the broadcasting demultiplexer 230 separates broadcasting streams and signaling information (S220). The broadcasting demultiplexer 230 transfers signaling information to the signaling analysis server 250 and transfers a broadcasting stream that is selected by the service selector 260 to the service controller 270.

When the communication demultiplexer 240 receives a broadcasting signal corresponding to signaling information through the communication service receiver 220, the communication demultiplexer 240 extracts signaling information from the broadcasting signal (S230) and transfers the extracted signaling information to the signaling analysis server 250. When the communication demultiplexer 240 receives a broadcasting signal corresponding to the broadcasting stream through the communication service receiver 220, the communication demultiplexer 240 transfers the received broadcasting stream to the service controller 270. Further, when the communication demultiplexer 240 receives multiplexed broadcasting streams, the communication demultiplexer 240 separates the broadcasting stream that is selected by the service selector 260 and transfers the broadcasting stream to the service controller 270. The signaling analysis server 250 analyzes signaling information (S240). The signaling analysis server 250 determines a stream type, a transmitting network type, and a broadcasting time of each broadcasting program through analysis of signaling information, and transfers the stream type, the transmitting network type, and the broadcasting time to the service controller 270.

The service selector 260 selects a broadcasting program according to a viewer's instruction (S250), and transfers information of the selected broadcasting program to the broadcasting demultiplexer 230, the communication demultiplexer 240, and the service controller 270.

The signaling analysis server 250 determines whether a transmitting network type of the selected broadcasting program is a broadcasting network (S260), and if a transmitting network type of the selected broadcasting program is a communication network, the communication demultiplexer 240 requests streaming of the broadcasting stream of the selected broadcasting program from the streaming server 180 of the hybrid broadcasting transmitting apparatus 100 and transfers the broadcasting stream of a corresponding program that is received with streaming to the service controller 270 (S270).

If a transmitting network type of the selected broadcasting program is a broadcasting network at step S260, the broadcasting demultiplexer 230 transfers the broadcasting stream that is selected by the service selector 260 to the service controller 270.

The service controller 270 performs a function of managing and controlling broadcasting streams that are provided through a broadcasting network and a communication network. The service controller 270 transfers the broadcasting stream of the selected broadcasting program to the service player 280 based on a stream type, a transmitting network type, and a broadcasting time of the selected broadcasting program. If a transmitting network type of the selected broadcasting program is a broadcasting network, the service controller 270 transfers the broadcasting stream that is received through the broadcasting service receiver 210 to the service player 280. If a transmitting network type of the selected broadcasting program is a communication network, the service controller 270 transfers the broadcasting stream that is received through the communication service receiver 220 to the service player 280.

The service player 280 plays the broadcasting stream of a broadcasting program that is selected by the viewer and outputs the broadcasting stream through a screen (S280).

According to an exemplary embodiment of the present invention, by using a communication network as an auxiliary network of a broadcasting network by providing a transmitting network type of broadcasting program and transition information of a transmitting network through signaling information, when a broadcasting resource is insufficient due to a broadcasting service of a large capacity, such as a UHD broadcasting service, one program or a portion of a broadcasting service can be provided through the communication network. Thereby, various broadcasting services can be provided in consideration of a communication network as well as a broadcasting network.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting hybrid broadcasting using a broadcasting network and a communication network in a hybrid broadcasting transmitting apparatus, the method comprising:
generating signaling information comprising a stream type and a transmitting network type of a plurality of broadcasting programs;
transmitting the signaling information and broadcasting stream corresponding to a portion of the plurality of broadcasting programs through the communication network; and
transmitting the signaling information and broadcasting stream corresponding to the remaining portions of the plurality of broadcasting programs through the broadcasting network.

2. The method of claim 1, wherein the stream type of the broadcasting program represent image quality of the broadcasting program, and the transmitting network type represents the broadcasting network and the communication network.

3. The method of claim 1, wherein the signaling information further comprises transition information of a transmitting network of the plurality of broadcasting programs.

4. The method of claim 2, wherein the signaling information further comprises a related uniform resource locator (URL), when the transmitting network is a broadcasting program corresponding to a communication network.

5. The method of claim 1, wherein the transmitting of the signaling information and broadcasting stream corresponding to the remaining portions comprises:
multiplexing the signaling information and broadcasting streams of a broadcasting program of the remaining portions; and
transmitting the multiplexed signal through the broadcasting network.

6. The method of claim 1, wherein the transmitting of the signaling information and broadcasting stream corresponding to a portion comprises streaming each of the signaling information and broadcasting streams corresponding to the portion through the communication network.

7. A method of receiving hybrid broadcasting using a broadcasting network and a communication network in a hybrid broadcasting receiving apparatus, the method comprising:
receiving signaling information comprising a stream type and a transmitting network type of each broadcasting program from the hybrid broadcasting transmitting apparatus;
analyzing the signaling information;
selecting a broadcasting program to view among a plurality of broadcasting programs; and
playing a broadcasting stream that is provided through the communication network and the broadcasting network according to a transmitting network type of the selected broadcasting program based on the signaling information.

8. The method of claim 7, wherein the stream type of the broadcasting program represents image quality of the broadcasting program, and the transmitting network type represents the broadcasting network and the communication network.

9. The method of claim 8, wherein the signaling information further comprises transition information of a transmitting network of the plurality of broadcasting programs.

10. The method of claim 8, wherein the signaling information further comprises a related uniform resource locator (URL), when the transmitting network is a broadcasting program corresponding to a communication network.

11. The method of claim 7, wherein the playing of broadcasting stream comprises:
requesting streaming of the selected broadcasting program, when a transmitting network type of the selected broadcasting program is the communication network; and
receiving a broadcasting stream of the selected broadcasting program by streaming through the communication network.

12. The method of claim 7, wherein the playing of broadcasting stream comprises receiving a broadcasting stream through the broadcasting network, when a transmitting network type of the selected broadcasting program is the broadcasting network, and
the broadcasting stream and the signaling information are multiplexed by the hybrid broadcasting transmitting apparatus to be transmitted through the broadcasting network.

13. An apparatus that transmits hybrid broadcasting using a broadcasting network and a communication network, the apparatus comprising:
a scheduling server that determines a stream type, a transmitting network type, and a broadcasting time of a plurality of broadcasting programs;
a signaling server that generates signaling information comprising a stream type, a transmitting network type, and a broadcasting time of the plurality of broadcasting programs;
a streaming server that transmits the signaling information and broadcasting stream of a broadcasting program to transmit to the communication network by streaming;
a broadcasting multiplexer that multiplexes the signaling information and broadcasting stream of a broadcasting program to transmit to the broadcasting network; and
a broadcasting service transmitter that transmits the multiplexed signal through the broadcasting network.

14. The apparatus of claim 13, wherein the stream type of the broadcasting program represent image quality of the broadcasting program, and the transmitting network type represents the broadcasting network and the communication network.

15. The apparatus of claim 13, wherein the signaling information further comprises transition information of a transmitting network of the plurality of broadcasting programs.

16. An apparatus that receives hybrid broadcasting using a broadcasting network and a communication network, the apparatus comprising:
a signaling analysis server that determines a stream type and a transmitting network type of each broadcasting program by analyzing signaling information that is transmitted through the broadcasting network and the communication network;
a service selector that selects a broadcasting program to view among a plurality of broadcasting programs; and
a service player that plays a broadcasting stream that is provided through the communication network or the broadcasting network according to a transmitting network type of the selected broadcasting program.

17. The apparatus of claim 16, further comprising:
a broadcasting service receiver that receives a signal in which the signaling information and broadcasting stream of the each broadcasting program is multiplexed through the broadcasting network; and
a communication service receiver that receives broadcasting stream of the each broadcasting program and the signaling information through the communication network by streaming.

18. The apparatus of claim 16, wherein the stream type of the broadcasting program represents image quality of the broadcasting program, and the transmitting network type represents the broadcasting network and the communication network.

19. The apparatus of claim 16, wherein the signaling information further comprises transition information of a transmitting network of the plurality of broadcasting programs.

20. The apparatus of claim 16, further comprising a service controller that transfers a broadcasting stream that is provided through the broadcasting network or the communication network according to a transmitting network type of the selected broadcasting program to the service player.
